(19) United States
(12) Patent Application Publication
(10) Pub. No.: US 2006/0159456 A1
(43) Pub. Date: Jul. 20, 2006

(54) System and method for conserving resources in an optical storage area network

(75) Inventors: Ashwin Anil Gumaste, Dallas, TX (US); Paparao Palacharla, Richardson, TX (US); Susumu Kinoshita, Plano, TX (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 11/037,943

(22) Filed: Jan. 18, 2005

(51) Int. Cl. H04B 10/20

(52) U.S. Cl. 398/59

(57) ABSTRACT

A method for providing a storage area network includes receiving, at a data storage node, data from a number of storage area network (SAN) servers via associated local nodes coupled to a optical network. The data is received at a plurality of transmitting wavelengths, where each local node is assigned a different transmitting wavelength. The method also includes storing the received data at the data storage node and sending acknowledgement messages to SAN servers to indicate receipt of the data. The acknowledgement messages are sent via the local nodes at a single receiving wavelength and each local node is configured to receive this receiving wavelength. The method may also include receiving, at the data storage node, a request for data stored at the data storage node from any of SAN servers via the associated local node at the assigned transmitting wavelength of the associated local node. Furthermore, the method may include sending the requested data from the data storage node to the requesting SAN sever via the associated local node at the receiving wavelength.

### TECHNICAL FIELD

The present invention relates generally to optical networks and, more particularly, to a system and method for conserving resources in an optical storage area network.

### BACKGROUND

The past several years have witnessed a large increase of data services and the use of computing as a tangible, rational and low cost, widely accepted ubiquitous method for data processing. Business needs have shifted from conventional paper-based transactions to the electronic domain, whereby large processing and storage of information is required in the electronic domain in storage banks. The critical nature of these storage banks requires them to be reliable and available when needed. Reliability can be increased if the storage bank is located in a centralized location that is available to multiple users. This type of network in which computing devices back up critical data at a remote location is known as a storage area network (SAN). The storage banks are located at one or more centralized locations and are connected to the computing devices via a wide area network (WAN) or other suitable network. Such a network may comprise a number of optical add/drop nodes that are coupled by fiber optic links. Data transfers between the remote computing devices and the storage bank through such fiber optic links may be performed using any suitable SAN communication protocol, such as Fibre Channel, ESCON, or FiCON. Such communications may be added to the network in different wavelengths of an optical signal, known as wavelength division multiplexing (WDM). To support such communication over an optical network, optical transmitters are used to convert electronic signals onto a wavelength of light and optical receivers are used to reverse this conversion thereby regenerating the electronic signal from the optical signal. Such transmitters and receivers are expensive network components and studies have shown such components to consume eighty percent of the network costs. Therefore, the number of these components in an optical SAN greatly affects the cost required to implement such a network.

### SUMMARY

A method and system for conserving resources in an optical storage area network are provided. In one embodiment, a method for providing a storage area network includes receiving, at a data storage node, data from a number of storage area network (SAN) servers via associated local nodes coupled to a optical network. The data is received at a plurality of transmitting wavelengths, where each local node is assigned a different transmitting wavelength. The method also includes storing the received data at the data storage node and sending acknowledgement messages to SAN servers to indicate receipt of the data. The acknowledgement messages are sent via the local nodes at a single receiving wavelength and each local node is configured to receive this receiving wavelength. The method may also include receiving, at the data storage node, a request for data stored at the data storage node from any of SAN servers via the associated local node at the assigned transmitting wavelength of the associated local node. Furthermore, the method may include sending the requested data from the data storage node to the requesting SAN sever via the associated local node at the receiving wavelength.

Technical advantages of certain embodiments of the present invention include providing a scheme to implement storage area networking protocols over a WDM hub and spoke network that reduces the number of transmitters and receivers that are required in the network. The scheme makes use of an optical “drop and continue” (or “broadcast and select”) methodology to allow for this reduction in the number of transmitters and receivers. This reduction results in significant cost savings when implementing such a network. For example, the cost to implement a network including ten to sixteen nodes using forty to eighty wavelengths may be reduced around twenty to thirty percent.

It will be understood that the various embodiments of the present invention may include some, all, or none of the enumerated technical advantages. In addition other technical advantages of the present invention may be readily apparent to one skilled in the art from the figures, description, and claims included herein.

### BRIEF DESCRIPTION OF THE DRAWINGS

FIG. 1 is a block diagram illustrating an optical storage area network in accordance with one embodiment of the present invention;

FIG. 2 is a block diagram illustrating one embodiment of a local node of the network of FIG. 1;

FIG. 3 is a block diagram illustrating an example normal mode of operation of the optical storage area network of FIG. 1; and

FIG. 4 is a block diagram illustrating an example failure mode of operation of the optical storage area network 10 of FIG. 1.

### DETAILED DESCRIPTION OF THE DRAWINGS

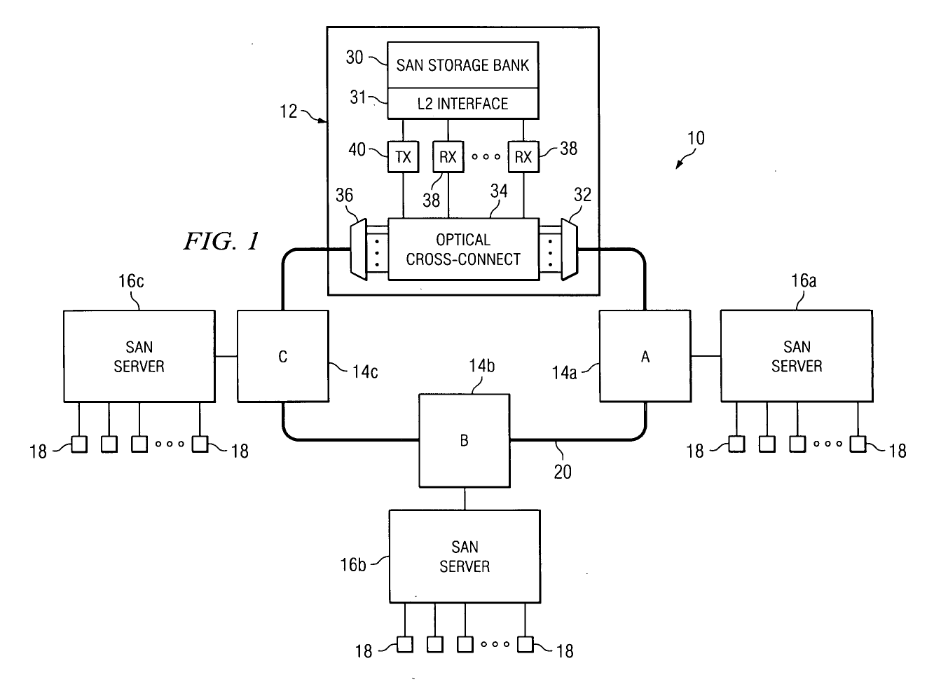

FIG. 1 illustrates an optical storage area network 10 in accordance with one embodiment of the present invention. The illustrated embodiment is an optical ring network; however, other suitable types of optical networks (such as an optical mesh network) may be used in accordance with the present invention. An optical ring may include, as appropriate, a single, uni-directional fiber, a single, bi-directional fiber, or a plurality of uni- or bi-directional fibers. The network 10 is operable to communicate traffic in a number of optical channels that are carried over a common path at different wavelengths. The network 10 may be a wavelength division multiplexed network, a dense wavelength division multiplexed network, or any other suitable multi-channel network.

Referring to FIG. 1, the network 10 includes a data storage node 12 (which includes a SAN storage bank 30) and a plurality of local nodes 14 coupled to an optical ring 20. The “hub and spoke” model depicted in FIG. 1 is a common model for SAN transport. Each spoke node (the local nodes 14 in FIG. 1) is connected to a SAN server 16 which collects data from various clients and packages this data into a SAN protocol and initiates transmission to the storage bank 30 of the hub node (the data storage node 12). The hub node/data storage node 12 is thus a single, reliable collection point for data storage.

In particular embodiments, ring 20 comprises two unidirectional fibers—one transporting traffic in a clockwise direction and the other transporting traffic in a counterclockwise direction. The ring 20 optically connects the plurality of local nodes 14a, 14b, and 14c and the data storage node 12. Each local node 14 may both transmit traffic to and receive traffic from the data storage node 12 to enable storage of data in and retrieval of data from the data storage node 12. Such traffic typically comprises optical signals having at least one characteristic modulated to encode the data to be stored or retrieved or other suitable data. This modulation may be based on phase shift keying (PSK), intensity modulation (IM), or any other suitable techniques.

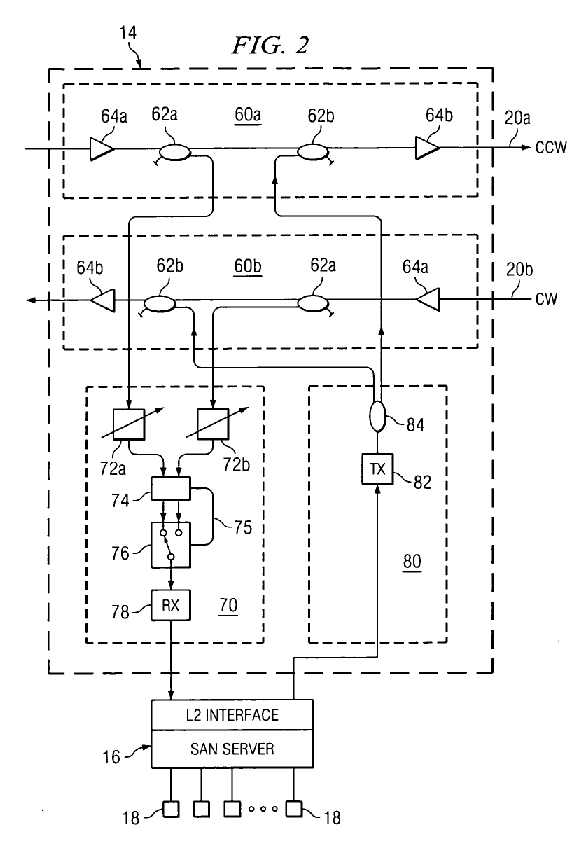

The local nodes 14, an embodiment of which is further described with reference to FIG. 2, are each operable to add and drop traffic to and from the ring 20. Each local node 14 is coupled to a SAN server 16, which is in turn coupled to one or more clients 18. The clients 18 send data to the SAN server 16 to be stored and also send requests to the SAN server 16 for data to be retrieved. Each SAN server 16 receives data from the clients 18 and puts the data into the proper format for communication to the data storage node 12 for storage in the storage bank 30 according to the SAN communication protocol being used. The SAN servers 16 then forward these SAN communications to the associated local node 14 for communication over ring 20 to the data storage node 12. The local nodes 14 each add such communications to the network 10 in a particular wavelength, as described below. Furthermore, each local node 14 receives traffic from the ring 20 and drops traffic destined for it (or, more particularly, for its associated SAN server 16). As described below, such traffic may be acknowledgements of data received or data sent to the server for purposes of data recovery. Traffic may be dropped from the ring 20 by making the traffic available for transmission to the associated SAN server 16, yet allowing the traffic to continue to circulate in the ring 20. This is typically referred to as “drop and continue.” Local nodes 14 provide optical-to-electrical conversion of the traffic dropped from the ring 20 for communication to the associate SAN server 16. In particular embodiments, traffic is passively added to and dropped from the ring 20 using an optical coupler or other suitable device, as described in further detail below. “Passively” in this context means the adding or dropping of channels without using optical switches that use power, electricity, and/or moving parts.

Each local node 14 is operable to drop traffic transmitted at a particular receiving wavelength λ_{R}. Each local node 14 electrically converts traffic transmitted at λ_{R} and communicates the traffic to the associated SAN server 16. The SAN server 16 extracts portions of the traffic destined for it based on addressing information in the traffic. Addressing information may include a header, tag, or any other suitable addressing information. In certain embodiments, each SAN sever 16 comprises a Layer 2 (L2) interface that forwards the appropriate portion of the traffic to the server 16 based on the addressing information.

Each local node 14 may also be assigned a sub-band (or a portion of a sub-band) for adding traffic to optical network 10 that is different from sub-bands assigned to the other local nodes 14. A subband, as used herein, means a portion of the bandwidth of the network. In particular embodiments, the sub-band assigned to each local node 14 is a wavelength of an optical signal. For example, local node 14a may be assigned a wavelength λ₁, wherein local node 14a adds traffic transmitted at the wavelength λ₁ to the ring 20. Similarly, continuing with this example, local nodes 14b and 14c may be assigned wavelengths λ₂ and λ₃, respectively, to add traffic to the ring 20. These transmitting wavelengths λ₁, λ₂, and λ₃ may be different from the receiving wavelength λ_{R} to prevent interference in the network. As will be described below, this wavelength assignment scheme serves to reduce the number of transmitters and receivers required in network 10.

Data storage node 12 receives optical signals from local nodes 14 (including, for example, data to be stored in the storage bank 30 and requests for stored data) and transmits optical signals (including, for example, acknowledgements of data transmissions and responses to data requests) to the local nodes 14 at the receiving wavelength. Optical signals, as used herein, include wavelengths which carry traffic in network 10. As used herein, “traffic” means information transmitted, stored, or sorted in the network, including any data to be stored in the storage bank 30 (and associated information), requests for data to be retrieved from storage bank 30, and data sent in response to such requests, as discussed in more detail below.

In the illustrated embodiment, the data storage node 12 includes the storage bank 30, a Layer 2 interface 31 to the storage bank 30, a demultiplexer 32, an optical cross-connect, a multiplexer 36, a plurality of receivers 38, and a transmitter 40. The demultiplexer 32 demultiplexes WDM or other multichannel optical signals transmitted over the optical ring 20 into constituent wavelengths and sends the traffic in each wavelength to the optical cross-connect 34. The cross-connect 34 allows the traffic in any of the received wavelengths to be communicated to any one of the receivers 38. Although in some embodiments the cross-connect 34 may be omitted and each receiver 38 may be connected to a particular output of demultiplexer 32, the use of the cross-connect 34 provides for flexible assignment of wavelengths in network 10. Each optical receiver 38 receives the traffic in one or more of the wavelengths demultiplexed by the demultiplexer 32 and converts the optical traffic into electrical traffic. The traffic is then forwarded to the L2 interface 31. The L2 interface 31 retrieves Layer 2 addressing information from the traffic and uses this information to properly direct the data or other information contained in the traffic to the storage bank according to the particular communication protocol being used. The L2 interface 31 and/or the storage bank 30 may have a traffic buffer in which to store traffic after it is received and before it is processed. Furthermore, the storage bank 30 may include a controller or other logic that performs the processing done by the storage bank 30 to store and retrieve data in and from a storage medium included as part of the storage bank 30. The storage bank 30 may alternatively or additionally include any other appropriate components, including those well-known in the field of storage area networking.

The data storage node 12 receives the data or other information from the local nodes 14 and process the data appropriately according to the data or information received. For example, the storage area network 10 may operate in two states: normal mode and failure mode. In the normal mode, the local nodes 14 send data to the data storage node 12 to be backed up. The data storage node 12 receives this data and stores it in the storage bank 30. The data storage node 12 also sends an acknowledgement message (ACK) to the server 16 that sent the data to be stored (for example, indicating that the data was received and stored). The SAN servers 16 connected to the local nodes 14 may also store a mirrored copy of the data sent by the server 16 to the data storage node 12. In the failure mode, a particular SAN server 16 connected to a local node 14 fails and thus loses some or all of the data that is stored at the server 16 (and that is backed-up at the data storage node 12). In the event of such a failure, the server 16 can request (via a communication sent through the associated local node 14) that the lost data be recovered from the storage bank 30 of the data storage node 12. Upon receiving such a request from a server 16, the data storage node 12 then sends the lost data from storage bank 30 to the local node 14 to which the failed server 16 is coupled. The failed server 16 then is resurrected. Such data recovery may occur in real time.

Communications sent from the data storage node 12 to a local node 14 and its associated SAN server 16 (such as ACKs or requested data) are communicated from the storage bank 30 via the L2 interface 31 to the transmitter 40. Again, the traffic may be temporarily stored in a buffer in the storage bank 30 and/or the L2 interface 31. The transmitter 40 encodes the data or other information as an optical information signal at the receiving wavelength λ_{R}. The traffic in λ_{R} is then communicated to the demultiplexer 36 (via the optical cross-connect 34, if appropriate). The demultiplexer 36 then multiplexes this traffic from the storage bank 30 with any other traffic forwarded to the demultiplexer 36 by the cross-connect 34 (for example, traffic sent from one local node 14 to another local node 14 via the data storage node 12). The demultiplexer then communicates this combined traffic on ring 20 to the local nodes 14 (although in some embodiments the only traffic transmitted from the data storage node 12 may be the traffic in λ_{R}).

If the above-mentioned operations are performed using a hub and spoke WDM optical network that does not include passive drop and continue local nodes 14 as the spoke nodes and that includes a total of N nodes (N-1 spoke nodes and one hub node), 4(N-1) “transponders” are required. “Transponder,” as used herein, refers to either a transmitter or a receiver. Because the N-1 spoke nodes each transmit data to the hub node, a total of N-1 transmitters are required at the spoke nodes. Similarly, N-1 different receivers are required at the hub node—each receiver receives the traffic from one of the transmitters at the spoke nodes. Furthermore, because the hub node needs to send acknowledgement messages to each spoke node in a different wavelength (since there is no drop and continue), N-1 transmitters are required at the hub node and N-1 corresponding receivers are required at the spoke nodes (one at each spoke node). These latter 2(N-1) transponders are also used for disaster recovery (when a spoke node fails, the hub node transmits data back to the spoke server through these transponders). Therefore, a total of 4(N-1) transponders are required in such a network. However, such transponders are expensive and such a network is thus costly to implement. However, embodiments of the present invention provide a SAN, for example network 10, that only requires a total of 3(N-1)+1 transponders—thus reducing the cost of implementing the network. Details regarding the implementation of these transponders according to embodiments of the present invention are provided below.

FIG. 2 illustrates one embodiment of a local node 14 according to the present invention. The node 14 comprises a first (counterclockwise) transport element 60a, a second (clockwise) transport element 60b, a receiving element 70, and a transmitting element 80. The transport elements 60 add and drop traffic to and from the fibers 20 (in this embodiment, ring 20 comprises two uni-directional fibers 20a and 20b), the transmitting element 80 generates local add signals to be added to the fibers 20 by the transport elements 60, and the receiving element 70 receives drop signals dropped from the fibers 20 by the transport elements 60. In particular embodiments, the transport, transmitting, and receiving elements 60, 70 and 80 may each be implemented as a discrete card and interconnected through a backplane of a card shelf of the node 14. Alternatively, the functionality of one or more of elements 60, 70 and 80 may be distributed across a plurality of discrete cards. The components of node 14 may be coupled by direct, indirect or other suitable connection or association. In the illustrated embodiment, the elements 60, 70 and 80 and the devices in the elements are connected with optical fiber connections, however, other embodiments may be implemented in part or otherwise with planar wave guide circuits, free space optics or using other suitable techniques.

The transport elements 60 are positioned “in-line” on fibers 20a and 20b. In the illustrated embodiment, the transport elements 60 each comprise a drop coupler 62a, an add coupler 62b, and two amplifiers 64. The amplifiers 64 amplify the optical signal received by each transport element 60 (before it is received at the drop coupler 62a) and amplify the optical signal communicated from the add coupler 62b of each transport element 60. The amplifiers 64 may be EDFAs or other suitable amplifiers capable of receiving and amplifying an optical signal. To reduce the optical power variations of the fibers 20, the amplifiers 64 may use an ALC function with wide input dynamic-range. Hence, the amplifiers 64 may deploy AGC to realize gain-flatness against input power variation, as well as VOAs to realize ALC function.

Transport elements 60 may comprise either a single add/drop coupler or separate add and drop couplers which allow for the passive adding and dropping of traffic. In the illustrated embodiment, a separate drop coupler 62a and add coupler 62b are used in each transport element 60. Each drop coupler 62a is operable to split a received optical signal into a drop signal and a substantially similar pass-through signal. Each add coupler 62b is operable to add/combine the signal generated by the transmitting element 80 to this pass-through signal. Each coupler 62 may comprise an optical fiber coupler or other optical splitter operable to combine and/or split an optical signal. As used herein, an optical splitter or an optical coupler is any device operable to combine or otherwise generate a combined optical signal based on two or more optical signals and/or to split or divide an optical signal into discrete optical signals or otherwise passively discrete optical signals based on the optical signal. The discrete signals may be similar or identical in frequency, form, and/or content. For example, the discrete signals may be identical in content and identical or substantially similar in power, may be identical in content and differ substantially in power, or may differ slightly or otherwise in content.

During operation of node 14, the amplifier 64a of each transport element 60 receives an optical signal from the connected fiber 20 and amplifies the signal. The amplified signal is forwarded to the drop coupler 62a. The drop coupler 62a splits the signal into a pass-through signal and a drop signal. The drop signal typically includes the same content as the pass-through signal. The pass-through signal is forwarded to the add coupler 62b. The drop signal is forwarded from the drop coupler 62a to the receiving element 70. The add coupler 62b combines the pass-through signal with any signals generated by the transmitting element 80 and forwards this combined signal to the amplifier 64b, where it is amplified and forwarded on the associated fiber 20.

The receiving element 70, which receives the drop signal from coupler 62a, selectively passes the traffic in the receiving wavelength (λ_{R}) to a receiver 78. To accomplish this, the receiving element 70 includes two tunable (or fixed) filters 72, a selector 74, a 2×1 switch 76, and the receiver 78. The drop signal from each fiber 20 is received at an associated filter 72a or 72b. Each filter 72 is configured to pass the traffic in λ_{R}. This passed traffic from each filter 72a and 72b is then forwarded to the selector 74 and switch 76, which allow selective connection of the receiver 78 to either traffic coming from fiber 20a or from fiber 20b. Such selective switching may be used to implement OUPSR or other similar protection switching. In a particular embodiment, the selector 74 is initially configured to forward to the associated server 16 traffic from a fiber 20 that has the lower BER. A threshold value is established such that the switch remains in its initial state as long as the BER does not exceed the threshold. Another threshold or range may be established for power levels. For example, if the BER exceeds the BER threshold or if the power falls above or below the preferred power range, the selector 74 selects the other signal by commanding the switch 76 to pass the other signal. Commands for switching may be transmitted via connection 75. This results in local control of switching and simple and fast protection. However, other protection schemes or no protection schemes may be used in other embodiments.

The selected signal comprising the traffic in λ_{R} passed by the associated filter 72 is then forwarded from the switch 76 to the receiver 78. The receiver converts the optical traffic into an electrical signal, which is then forwarded from the node 14 to the associated SAN server 16. In the illustrated embodiment, the SAN server 16 includes a L2 interface which receives and processes this traffic. For example, since all traffic transmitted from the data storage node 12 to any node 14 of network 10 is in a single wavelength (λ_{R}), the L2 interface can analyze the addressing information in the traffic (in accordance with the selected SAN communications protocol) to determine what portions of the traffic are destined for the associated SAN server 16. The L2 interface may then forward such portions of the traffic to the server 16, while discarding the remainder of the traffic received from the node 14.

The transmitting element 80 includes a transmitter 82 and a coupler 84. In particular embodiments, the transmitter 82 may be a burst mode transmitter. The transmitter 82 receives data or other traffic from SAN server 16 to be added to ring 20 (for example, for communication to the data storage node 12). The transmitter 82 converts this electrical traffic into optical traffic in the wavelength assigned to the node, as described below, which is different than the receiving wavelength, λ_{R}. This optical traffic is then split at coupler 84 to form two substantially identical signals. One of these signals is forwarded to the add coupler 62b of transport element 60a and the other signal is forwarded to the add coupler 62b of transport element 60b. Each add coupler 62b then combines this traffic from transmitter 82 with the pass-through signal from coupler 62a, and this combined signal is forwarded on the associated fiber 20.

Therefore, for use in a SAN such as network 10, each node 14 includes a single receiver 78 to receive communications from the data storage node 12 (such as acknowledgements of received data and data sent for the purposes of data recovery) and a single transmitter 82 to send communications from the node 14 to the data storage node 12 (such as data to be backed-up in the storage bank 30 and acknowledgements of received data sent from the data storage node 12 for data recovery). Therefore, in a network including N-1 local nodes 14, the total number of transponders in the local nodes 14 of network 10 is 2(N-1). Furthermore, as described and illustrated in conjunction with FIG. 1, the data storage node 12 includes N-1 receivers 38 that each receive the traffic communicated from the transmitter 82 of one of the local nodes 14. Finally, the data storage node 12 includes a single transmitter 40 used to communicate traffic to the local nodes 14 (which is received by the receiver 78 of each local node 14). Therefore, as described above, such a network includes a total of 3(N-1)+1 transponders—resulting in N-2 less transponders than in a typical WDM network that does not implement passive drop and continue local nodes 14. An example operation of network 10 using these 3(N-1)+1 transponders follows.

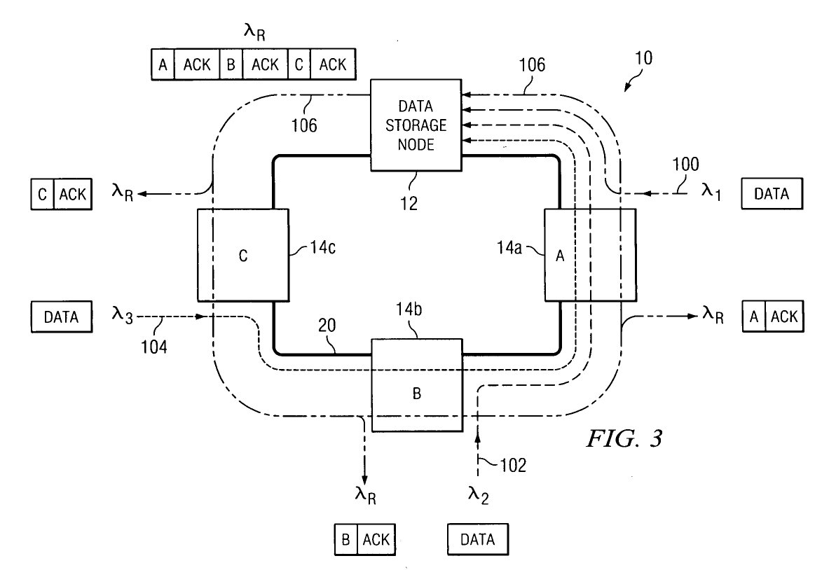

FIG. 3 is a block diagram illustrating an example normal mode of operation of the optical storage area network 10 of FIG. 1. In this normal mode of operation, each of the local nodes 14 transmits traffic to the data storage node 12 that includes data to be backed-up in the storage bank 30 of the data storage node 12. This upstream traffic to the data storage node 12 is sent from each local node 14 in a different transmitting wavelength to avoid interference between the traffic from each node 14. In the illustrated embodiment, node 14a transmits optical traffic stream 100 at λ₁, node 14b transmits optical traffic stream 102 at λ₂, and node 14c transmits optical traffic stream 104 at λ₃. Although not illustrated, traffic streams 100, 102, and 104 may include any appropriate header or other information in addition to the data to be backed-up (for example, an indication of what node 14 and/or associated SAN server 16 the traffic originated from). Furthermore, although traffic streams 100, 102, and 104 are shown as being concurrently transmitted, this traffic from each node 14 may be sent at any appropriate times. Finally, although traffic streams 100, 102, and 104 are only shown as being transmitted in one direction around ring 20, these traffic streams may be communicated in both direction to provide OUPSR protection (and the same applies to traffic sent from the data storage node 12).

The data storage node 12 receives the traffic streams 100, 102, and 104 and processes the traffic as described above. This processing includes storing the data contained in the traffic streams in the storage bank 30. In response to receiving the data, the data storage node 12 generates acknowledgement messages to be sent to each node 14 to acknowledge receipt of the data sent from the nodes 14. As illustrated in FIG. 3, each acknowledgement message has associated addressing information indicating the node 14 and associated server 16 for which the message is destined. Furthermore, any other suitable information may also be included with the message. These acknowledgement messages are time division multiplexed into a single traffic stream and this stream is communicated to the transmitter 40 of the data storage node 12 for transmission as optical traffic stream 106 at the receiving wavelength λ_{R}. In order to prevent interference, the receiving wavelength λ_{R} is different from the transmitting wavelengths λ₁, λ₂, and λ₃.

As described above, the local nodes 14 are each configured to passively split any optical signal received at the node 14 (which in this case includes at least traffic stream 106) into a drop signal and a pass-through signal. Each node 14 forwards the traffic stream 106 (after filtering the stream 106 from the drop signal and converting it to an electrical signal) to the associated SAN server 16. The L2 interface of the server 16 examines the addressing information associated with the various acknowledgement messages in the traffic stream and forwards on the messages that have addressing information identifying the associated SAN server 16 (in the illustrated embodiment, “A,” “B,” and “C” are used to identify both the node 14 and its associated server 16, although any suitable addressing scheme may be used). Messages having addressing information that does not match with the associated SAN server 16 are discarded. Such messages are still contained in the pass-through signal forwarded by each node 14, so these discarded messages are not needed (stream 106 is eventually terminated at the data storage node 12 to prevent its recirculation around ring 20). The forwarded acknowledgment messages are then processed by the SAN server 16 according to particular SAN protocol being used. Because the acknowledgment messages are relatively small in size, these messages typically do not use much of the bandwidth that is available on λ_{R}. Therefore, as is described below, this wavelength may also be used when network 10 is in failure mode to transport data from the data storage node 12 to a local node 14 for data recovery.

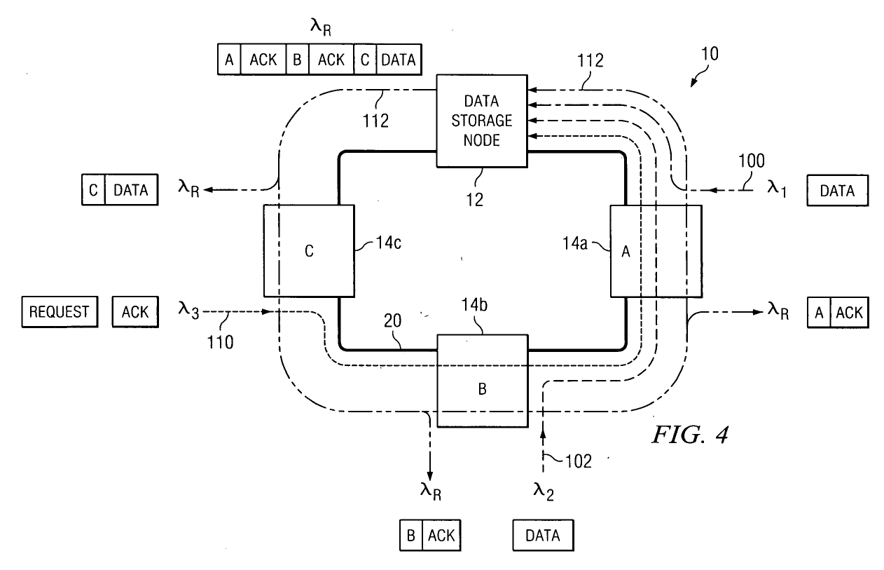

FIG. 4 is a block diagram illustrating an example failure mode of operation of the optical storage area network 10 of FIG. 1. The failure mode occurs when the SAN server 16 associated with one of the local nodes 14 fails and needs to recover data from the data storage node 12. In the illustrated example, the server 16 associated with local node 14c has failed and requires recovery of data from the data storage node 12. The servers 16 associated with local nodes 14a and 14b remain operational and continue communicating data to the data storage node 12 for back-up. Specifically, nodes 14a and 14b continue to transmit traffic streams 100 and 102 at λ₁ and λ₂, respectively, to the data storage node 12. Again these traffic streams 100 and 102 includes data to be backed-up in the storage bank 30 of the data storage node 12. However, since local node 14c has failed, this node 14c does not send data to be backed-up but instead sends a request for data to be recovered from the storage bank 30. This request for data is transmitted from node 14c as optical traffic stream 110 at λ₃.

The data storage node 12 receives the traffic streams 100, 102, and 110 and processes the traffic. With respect to traffic streams 100 and 102, as described above, this processing includes storing the data contained in the traffic stream in the storage bank 30. In response to receiving the data in traffic streams 100 and 102, the data storage node 12 generates acknowledgement messages to be sent to nodes 14a and 14b to acknowledge receipt of the data sent from the nodes 14. As illustrated in FIG. 4, each acknowledgement message has associated addressing information indicating the node 14 and associated server 16 for which the message is destined. Furthermore, any other suitable information may also be included with the message.

In addition, the data storage node 12 receives the traffic stream 110 from node 14c which contains a request for data as a result of the failure of the SAN server 16 associated with node 14c. In response to receiving the data request in traffic stream 110, the data storage node 12 retrieves appropriate data from its storage bank 30 (according to the SAN protocol being used) and generates a message to node 14c including at least a portion of the requested data. The requested data may typically be split between a number of frames or packets, according to the particular SAN communication protocol being used. Each of these frames typically has addressing information indicating the node 14 and associated server 16 for which the data is destined.

The acknowledgement messages to nodes 14a and 14b and the data destined for node 14c are time division multiplexed into a single traffic stream and this stream is communicated to the transmitter 40 of the data storage node 12 for transmission as optical traffic 112 at the receiving wavelength λ_{R}. As described above, the local nodes 14 are each configured to passively split any optical signal received at the node 14 (which in this case includes at least traffic 112) into a drop signal and a pass-through signal. Each node 14 forwards the traffic 112 (after filtering the traffic 112 from the drop signal and converting it to an electrical signal) to the associated SAN server 16.

The L2 interface of the server 16 examines the addressing information associated with the various acknowledgement messages or data in the traffic and forwards on the acknowledgement messages or data that have addressing information identifying the associated SAN server 16 (in the illustrated embodiment, “A,” “B,” and “C” are used to identify both the node 14 and its associated server 16, although any suitable addressing scheme may be used). Messages having addressing information that does not match with the associated SAN server 16 are discarded. Therefore, node 14c receives and drops traffic stream 112 to its associated SAN server 16. The server uses the data that it requested and received from data storage node 12 for recovery purposes and discards the acknowledgement messages destined for nodes 14a and 14c. Furthermore, node 14c sends an acknowledgement message to the data storage node 12 at 3 indicating that it received the requested data. Likewise, nodes 14a and 14b process the acknowledgement messages destined for those nodes and discard the remaining traffic in stream 112 (including the data destined for node 14c). The stream 112 is terminated upon reaching the data storage node 12 to prevent its recirculation.

In this manner, network 10 provides for a fully-operational storage area network that can be implemented using standard SAN communication protocols, but that requires significantly less transponders to implement. This lower number of transponders reduces the cost to implement the network and thus makes such a network a more cost-effective solution. Although the present invention has been described in detail, various changes and modifications may be suggested to one skilled in the art. It is intended that the present invention encompass such changes and modifications as falling within the scope of the appended claims.

What is claimed is:

1. A storage area network (SAN), comprising:
one or more local nodes coupled to an optical network and configured to passively drop and pass-through optical signals received from the optical network;
one or more SAN servers, each SAN server coupled to a local node and operable to receive data from one or more clients, store the data at the SAN server, communicate the data to a data storage node via the associated local node for storage at the data storage node, and request that the data be recovered from the data storage node upon failure of the SAN server;
the data storage node coupled to the optical network and,operable to receive data for storage from the SAN servers via the local nodes and to send data requested by the SAN servers;
each local node comprising a transmitter configured to send data from the associated SAN server to the data storage node at an assigned transmitting wavelength, each local node having a different assigned transmitting wavelength, the transmitter further configured to send at the assigned transmitting wavelength a request for data stored at the data storage node upon a failure of the SAN server associated with the local node;
each local node further comprising a receiver configured to receive, at a receiving wavelength different than the transmitting wavelengths, acknowledgement messages from the data storage node indicating receipt of data sent by the local node, the same receiving wavelength being used by each local node, the receiver further configured to receive data from the data storage node at the receiving wavelength sent in response to a request for the data from the local node;
the data storage node comprising a plurality of receivers, each receiver configured to receive data and requests for data from the transmitter of one of the local nodes at the associated transmitting wavelength; and
the data storage node further comprising a transmitter configured to send acknowledgement messages and requested data to each local node at the receiving wavelength.

2. The storage area network of claim 1, wherein the storage area network comprises one data storage node and N-1 local nodes for a total of N nodes, and wherein the storage area network includes a total of N transmitters and a total of 2(N-1) receivers.

3. The storage area network of claim 1, wherein each local node comprises:
one or more optical couplers collectively configured to passively drop optical signals from the optical network and to passively add optical signals received from the transmitter of the local node to the optical network; and
at least one filter operable to pass traffic at the receiving wavelength of the optical signals dropped from the one or more optical couplers to the receiver of the local node.

4. The storage area network of claim 1, wherein the transmitter of each local node comprises a burst mode transponder.

5. The storage area network of claim 1, wherein each acknowledgement message and data sent from the data storage node includes a header identifying the destination SAN server, and wherein each SAN server further comprising an interface operable to select the acknowledgement messages and data destined for the SAN server based on the addressing information and to discard the remaining acknowledgement messages and data.

6. The storage area network of claim 1, wherein the data storage node comprises a storage bank operable to store data received from the SAN servers.

7. The storage area network of claim 1, wherein the optical network comprises a ring network or a mesh network.

8. A data storage node coupled to an optical network, comprising:
a plurality of receivers configured to receive data from a plurality of storage area network (SAN) servers via a plurality of associated local nodes coupled to the optical network, the data received at a plurality of transmitting wavelengths, wherein each local node is assigned a different transmitting wavelength;
a storage bank operable to receive the data from the receivers and to store the data, the storage bank further operable to generate acknowledgement messages to the SAN servers indicating receipt of the data; and
a transmitter configured to send the acknowledgement messages to all of the SAN servers via the associated local nodes at a single receiving wavelength, wherein each local node is configured to receive the receiving wavelength.

9. The data storage node of claim 8, wherein each acknowledgement message sent from the data storage node includes a header identifying the destination SAN server, and wherein each SAN server further comprising an interface operable to select the acknowledgement messages destined for the SAN server based on the addressing information and to discard the remaining acknowledgement messages.

10. The data storage node of claim 8, wherein:
the receivers are further configured to receive a request for data stored at the data storage node from any of SAN servers via the associated local node at the assigned transmitting wavelength of the associated local node; and
the transmitter further configured to receive the requested data from the storage bank and to send the requested data to the requesting SAN sever via the associated local node at the receiving wavelength.

11. The data storage node of claim 10, wherein all data sent from the data storage node includes a header identifying the destination SAN server, and wherein each SAN server further comprising an interface operable to select the data destined for the SAN server based on the addressing information and to discard the remaining data.

12. A method for providing a storage area network, comprising:
at a data storage node coupled to an optical network, receiving data from a plurality of storage area network (SAN) servers via a plurality of associated local nodes coupled to the optical network, the data received at a plurality of transmitting wavelengths, wherein each local node is assigned a different transmitting wavelength;
storing the received data at the data storage node; and
sending, from the data storage node, acknowledgement messages to SAN servers via the associated local nodes to indicate receipt of the data, the acknowledgement messages sent to all of the local nodes at a single receiving wavelength, wherein each local node is configured to receive the receiving wavelength.

13. The method of claim 12, wherein each acknowledgement message sent from the data storage node includes a header identifying the destination SAN server, and further comprising, at each SAN server, selecting the acknowledgement messages destined for the SAN server based on the addressing information and discarding the remaining acknowledgement messages.

14. The method of claim 12, further comprising:
receiving, at the data storage node, a request for data stored at the data storage node from any of SAN servers via the associated local node at the assigned transmitting wavelength of the associated local node; and
sending the requested data from the data storage node to the requesting SAN sever via the associated local node at the receiving wavelength.

15. The method of claim 14, wherein all data sent from the data storage node includes a header identifying the destination SAN server, and further comprising, at each SAN server, selecting the data destined for the SAN server based on the addressing information and discarding the remaining data.
